(19) United States
(12) Patent Application Publication
(10) Pub. No.: US 2026/0192447 A1
(43) Pub. Date: Jul. 9, 2026

(54) HUMANOID ROBOT TELEOPERATION SYSTEMS AND APPLICATIONS

(71) Applicant: NVIDIA Corporation, Santa Clara, CA (US)

(72) Inventors: Zhenjia Xu, Mountain View, CA (US); Zhenyu Jiang, Austin, TX (US); Yuqi Xie, Santa Clara, CA (US); Yuke Zhu, Austin, TX (US); Linxi Fan, San Jose, CA (US)

(21) Appl. No.: 19/014,665

(22) Filed: Jan. 9, 2025

(51) Int. Cl. B25J 9/16; B25J 13/08

(52) U.S. Cl. CPC B25J 9/163; B25J 9/161; B25J 9/1689; B25J 9/1697; B25J 13/08

(57) ABSTRACT

In various examples, systems and methods of the present disclosure may independently control different components of a robotic system—such as a humanoid robot—by using sensors to track the movements of a teleoperator. For instance, a motion capture glove(s) worn by a teleoperator may be used to track the motion of the teleoperator's hand complex(es), while a spatial computing device (e.g., an Augmented Reality (AR), Virtual Reality (VR), and/or Mixed Reality (MR) headset) may be used to track the motion of the teleoperator's non-manual body parts. The sensor data from these different modalities may be used to map the motions of the teleoperator to corresponding components (e.g., body parts) of the humanoid robot. In some instances, a video depicting a first-person perspective view associated with the humanoid robot may be live streamed to the teleoperator for feedback while the teleoperator is controlling the humanoid robot.

### BACKGROUND

Across various technological fields, modern robotic systems may be used to perform—and in some cases automate—a variety of tasks, such as assembling products, managing inventory, conducting inspections, providing support in healthcare settings, or any other kinds of tasks. For instance, humanoid robots may often mimic human-like form and movement, making them valuable for tasks in environments designed for people, such as homes, factories, hospitals, or any other environment designed for people. Advances in sensors, actuators, and artificial intelligence have allowed humanoid robots and similar robotic systems to become more sophisticated and, in some instances, capable of navigating complex environments, manipulating objects, and interacting with humans.

Despite recent improvements in their performance, however, humanoid robots and/or robotic systems still face several challenges. For instance, some conventional systems may use controllers with buttons to open and close the fingers of a humanoid robot, which may not allow for independent control of each finger. Additionally, many conventional systems either have no video streaming or only stream a single image of what the robot is doing responsive to inputs. This lack of fine-grained control and limited sensory feedback presents challenges for tasks requiring dexterity, precision, and/or real-time awareness.

### SUMMARY

Embodiments of the present disclosure relate to humanoid robot teleoperation systems and applications. Systems and methods are disclosed that may independently control different components of a humanoid robot or any other type of robotic system by using sensors to track the movements of a teleoperator. For instance, a motion capture glove(s) worn by a teleoperator may be used to track the motion of the teleoperator's hand(s), and a spatial computing device (e.g., an Augmented Reality (AR), Virtual Reality (VR), and/or Mixed Reality (MR) headset) may be used to track the motion of the teleoperator's other body parts. The sensor data from these different modalities may be used to map the motions and/or poses of the teleoperator to corresponding components (e.g., body parts) of the humanoid robot. In some instances, a video depicting a first-person perspective view associated with the humanoid robot may be live streamed to the teleoperator for feedback while the teleoperator is controlling the humanoid robot.

In contrast to conventional systems, the systems of the present disclosure, in some embodiments, are able to, among other things, independently control each finger of a humanoid robot. As described in more detail herein, by using motion tracking gloves and/or a spatial computing device, the systems of the present disclosure may be able to directly track the motion of each finger of the teleoperator, allowing the systems to intuitively control dexterous hands of a humanoid robot. Furthermore, because the systems of the present disclosure may use multiple modalities of sensor data to track motion of the teleoperator, the systems of the present disclosure may offer redundancy and improved performance across a wide variety of scenarios. For instance, by using motion tracking gloves, the motion and/or poses made by a teleoperator's hand complex (e.g., wrists, hands, individual fingers, etc.) may be tracked and mapped to the humanoid robot even when the teleoperator's hands are occluded.

Additionally, in contrast to the conventional systems, the systems of the present disclosure, in some embodiments, are able to collect data from the humanoid robot while performing challenging tasks, which may be particularly useful for AI policy training. As described in more detail herein, by encoding and live streaming a view of a camera(s) that is mounted on the humanoid robot, the systems of the present disclosure are able to provide human teleoperators with first-person views from the perspective of the humanoid robot with higher resolution and lower latency than conventional systems, and these video streams may be stored and/or used for developing AI policies.

### BRIEF DESCRIPTION OF THE DRAWINGS

The present systems and methods for humanoid robot teleoperation systems and applications are described in detail below with reference to the attached drawing figures, wherein:

FIG. 1 is a data flow diagram illustrating an example of a process associated with remotely controlling motion of a robot using sensor data from different modalities of sensors, in accordance with some embodiments of the present disclosure;

FIG. 2 illustrates an example of a teleoperator remotely controlling a humanoid robot, in accordance with some embodiments of the present disclosure;

FIG. 3 illustrates example detail associated with using various sensor data inputs to determine a plurality of poses associated with a teleoperator, in accordance with some embodiments of the present disclosure;

FIG. 4 illustrates example detail associated with mapping various poses to control inputs to apply to motors or actuators of a robot, in accordance with some embodiments of the present disclosure;

FIG. 5 is a data flow diagram illustrating an example process for policy training one or more models, in accordance with some embodiments of the present disclosure;

FIG. 6 illustrates an example of a system that may perform one or more of the processes described herein, in accordance with some embodiments of the present disclosure;

FIG. 7 is a flow diagram illustrating an example of a method for using sensor data from different modalities of sensors to control different components of a robot, in accordance with some embodiments of the present disclosure;

FIG. 8 is a flow diagram illustrating an example of a method for controlling a robot to replicate motions or poses of a user, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to humanoid robot teleoperation systems and applications. As described herein, in some examples, a user (also referred to herein as a “teleoperator” or a “remote operator”) may control the operations and/or movements of a humanoid robot or similar robotic system by physically performing (e.g., acting out) the operations/movements that the user desires or intends for the humanoid robot to carry out. For instance, as the user makes various poses, gestures, or other movements, the systems and methods of the present disclosure may track these movements of the user using various sensing/motion tracking modalities, and then cause the humanoid robot to perform the same (or close to the same) movements. In some instances, these tracked movements of the user may include movement of individual fingers of the user, and the systems of the present disclosure may independently control the motion of individual fingers of the humanoid robot that correspond to the user's fingers. Additionally, in some examples, a video depicting a first-person perspective view associated with the humanoid robot may be live streamed to the user for feedback during teleoperation. For instance, the video may be live streamed to a spatial computing device—such as an Augmented Reality (AR), Virtual Reality (VR), and/or Mixed Reality (MR) headset—worn by the user, which may also be used to track at least some of the user's movements.

By way of example, and not limitation, a system(s) may obtain first sensor data generated using one or more first sensors of a first modality. For example, the first sensor(s) may include one or more sensors of a spatial computing device. As described above and herein, in some examples, the spatial computing device may include, but is not limited to, an AR headset, VR headset, or MR headset. The spatial computing device may be worn by a user to track at least some of the user's movements. For instance, the spatial computing device may be capable of tracking the movements and/or three-dimensional (3D) locations of the user's hands, fingers, wrists, arms, legs, feet, toes, shoulders, abdomen, neck, head, or any other body parts of the user. In some instances, the first sensor data may be indicative of one or more first poses associated with one or more first portions of the user. For instance, the first sensor data generated using the first sensor(s) may indicate poses, movements, joint angles, etc. of the user's non-manual body parts (e.g., head, neck, abdomen, shoulders, arms, hips, legs, knees, feet, toes). Additionally, in some examples, the first sensor data may track movements, poses, etc. of the user's entire body (e.g., manual and non-manual body parts).

In some examples, the system(s) may obtain second sensor data generated using one or more second sensors of a second modality, which may, in some instances, be different from the first sensor(s) of the first modality. For example, the second sensor(s) may include one or more sensors associated with motion tracking gloves worn by the user, or another wearable tracking device wearable by the user. As described herein, in some examples, the motion tracking gloves may include a number of sensors for sensing motion of the user's hand-related or manual body parts (e.g., hands, wrist, fingers, thumbs, etc.), which may also be referred to herein as the user's “hand complex(es)”. For instance, the motion tracking glove(s) may include sensors for tracking the movements, poses, 3D locations, joint angles, etc. of the user's wrists, hands, fingers, and/or thumbs. As such, the second sensor data generated using the second sensor(s) may be indicative of one or more second poses associated with one or more second portions of the user, which may be different than the first portion(s) of the user. In some instances, the motion tracking gloves of the present disclosure may be modified to include wrist tracking sensors to track the motion, position, and/or joint angle of the user's wrists. In this way, the motion tracking gloves may generate sensor data associated with not only hand, finger, and thumb movements, but also wrists movements as well.

In some examples, different portions of the second sensor data may be generated using different sensors of the motion tracking gloves. For instance, one or more first portions of the second sensor data may be generated using one or more finger tracking sensors of the glove, one or more second portions of the second sensor data may be generated using one or more hand tracking sensors of the glove, and one or more third portions of the second sensor data may be generated using one or more wrist tracking sensors of the glove.

In some instances, the system(s) may use the sensor data obtained from the sensors to determine poses, 3D locations, joint angles, etc. associated with the various different portions or body parts of the user. For instance, based at least on the first sensor data the system(s) may determine one or more first poses, locations, joint angles, etc. of the user's non-manual body parts. As an example, using the first sensor data the system(s) may determine that the non-manual portions of the user are forming a pose associated with the user standing, sitting, walking, running, lying down, jumping, bending over, etc. That is, the system(s) may use the first sensor data, which may be associated with a particular point in time (e.g., frame, timestep, etc.), to determine the pose of certain body parts of the user at that particular point in time. Similarly, based at least on the second sensor data the system(s) may determine one or more second poses, locations, joint angles, etc. of the user's manual body parts. As an example, using the second sensor data the system(s) may determine that the individual poses made by each one of the user's fingers, thumbs, hands, and/or wrists. That is, the system(s) may use the second sensor data, which may be associated with the same particular point in time, to determine the poses of the user's hands, fingers, thumbs, and wrists at that particular point in time.

In some examples, the system(s) may select the best sensor data (e.g., the first or the second sensor data) to use for determining the pose of the user based on one or more factors. For example, if the pose of the user results in the user's hand(s) being occluded from view of the spatial computing device, the system(s) may associate a higher confidence score with the sensor data from the second sensor(s) (e.g., motion tracking gloves) and use this sensor data to determine the pose of the user's hand(s). Additionally, in some examples, the system(s) may use both the first sensors and the second sensors to track the motion or poses of the same portions of the user, and average or interpolate between different sensor data measurements to determine the pose(s) of the user with greater accuracy, redundancy, etc. As an example, the system(s) may use sensor data obtained from both the spatial computing device and motion tracking gloves to track the poses and movements of the user's hand complexes. As an even further example, the system(s) may use the motion tracking gloves to track the location of the user's hands, and use the spatial computing device to track the location of the user's arms and/or other non-manual body parts, and then determine whether the location of the user's hands agree with the location of the rest of the user's body by combining the sensor data from the different modalities. For instance, if the motion tracking gloves indicate that the location of the user's hands are 10 feet away from the location of the rest of the user's body indicated by the spatial computing device, the system(s) may determine that one of the sensing modalities is experiencing a fault.

As described herein, in some examples, the system(s) may determine a plurality of rotation angles for a plurality of motors of the humanoid robot. For instance, based at least on the first sensor data, the system(s) may determine one or more first rotation angles for one or more first motors that control one or more first components of the robot. In various instances, the first component(s) may correspond to the first portion(s) of the user. In other words, using the first sensor data the system(s) may determine how much each one of the first motor(s) needs to rotate or actuate in order to cause the robot to mirror the poses, movements, joint angles, etc. of the first portion(s) of the user. As one example, if the joint angle of the user's right knee is 45-degrees, the system(s) may determine how much a motor(s) that controls the right knee of the humanoid robot needs to rotate or actuate to cause the right knee of the robot to bend to 45-degrees. Similarly, based at least on the second sensor data, the system(s) may determine one or more second rotation angles for one or more second motors that control one or more second components of the robot. In various instances, the second component(s) may correspond to the second portion(s) of the user. In other words, using the second sensor data the system(s) may determine how much each one of the second motor(s) needs to rotate or actuate in order to cause the second component(s) of the robot to mirror the poses, movements, joint angles, etc. made by the second portion(s) of the user. As another example, if the joint angle of the user's right index finger's metacarpophalangeal joint (the joint at the base of the index finger where it meets the hand) is 15-degrees, the system(s) may determine how much a motor(s) that controls the right index finger of the humanoid robot needs to rotate or actuate to make the right index finger of the robot correspond to the user's finger. In some examples, to map the poses of the user to the rotation angles for the motors of the robot, the system(s) may apply the values in the sensor data to one or more functions. For instance, the system(s) may use one or more inverse kinematics functions and/or other functions to determine the target rotation angles for each motor based on the sensor data.

In various examples, the system(s) may generate control signals for controlling the motors of the humanoid robot and then send these signals to the motors to actuate them and update the pose of the robot. For instance, based on determining the target rotation angles of the motors, the system(s) may generate the control signals to send to the motors to cause the motors to rotate in accordance with the target rotation angles. That is, by causing the motors to rotate or actuate, the motors may move the components/human-like features of the robot so that the pose of the robot corresponds to the pose of the user.

As described herein, in some examples the system(s) may stream a video depicting a first-person perspective view associated with the robot back to the user controlling the robot. For instance, a camera may be mounted on the humanoid robot's head (or another location), and the video may depict the humanoid robot's first-person view (e.g., a view of the environment surrounding the robot as seen through the “eyes” of the robot). In such examples, image data may be generated using the camera and used to stream the video back to the user. For instance, the video may be live streamed back to the spatial computing device, which may be worn upon the user's head, and the video displayed using a display of the spatial computing device so that the user can see what the humanoid robot is doing responsive to the user's motions.

In some examples, the system(s) may use the video or image data, as well as the actions performed by the user, for AI policy training of humanoid robots and/or other types of robotic systems. For instance, the data may be processed to identify specific patterns, gestures, or sequences of movements performed by the user, which can then be translated into actionable commands or behavioral models for the robots. These models may enable robots to mimic human actions, adapt to complex environments, or perform tasks with greater precision and autonomy. By analyzing user interactions and contextual cues, the system(s) may refine the training process, improving the robot's decision-making capabilities and task execution over time. This approach may also facilitate transfer learning, where knowledge gained from one task is applied to another, enhancing the versatility of robotic systems in various real-world applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

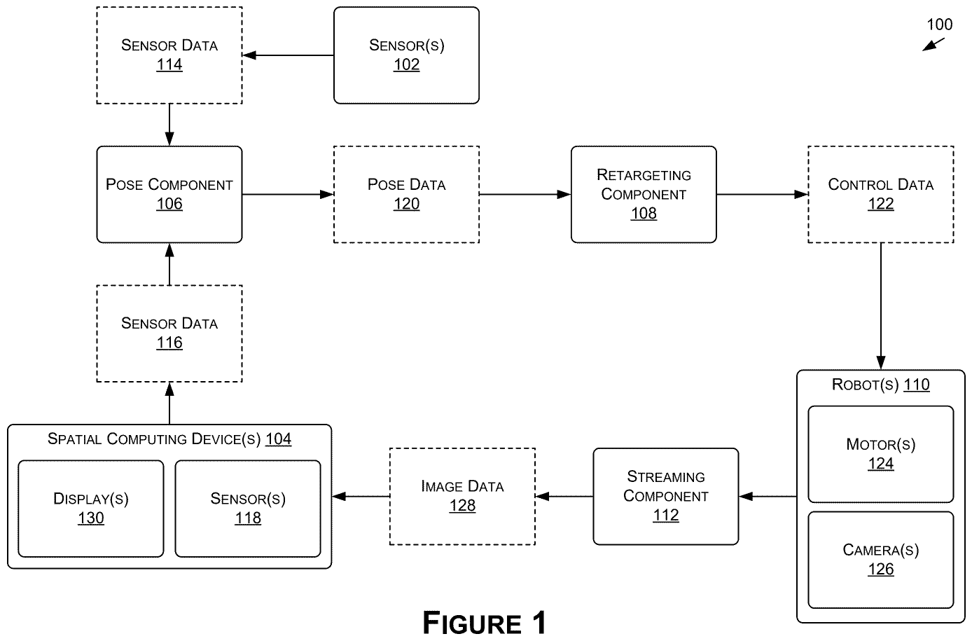

With reference to FIG. 1, FIG. 1 is a data flow diagram illustrating an example of a process 100 associated with remotely controlling motion of a robot using sensor data from different modalities of sensors, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may be implemented using, amongst additional or alternative components, one or more sensor(s) 102, one or more spatial computing device(s) 104, a pose component 106, a retargeting component 108, one or more robots 110, and a streaming component 112. Although depicted in the example of FIG. 1 as separate components, in some examples, the pose component 106, the retargeting component 108, and the streaming component 112 may be included in the robot(s) 110. That is, the pose component 106, the retargeting component 108, and/or the streaming component 112 may be, in some examples, stored in a memory of the robot(s) 110 and executed using one or more processors and/or computing devices of the robot(s) 110.

As a brief overview of the process 100, the pose component 106 may receive sensor data 114 generated using the sensor(s) 102, as well as sensor data 116 generated using one or more sensors 118 of the spatial computing device(s) 104, and use the sensor data 114 and 116 to generate pose data 120 indicative of one or more poses of one or more different portions of a user. The retargeting component 108 may receive the pose data 120 (and/or the sensor data 114 and/or 116) and use it to generate control data 122 for controlling one or more motors 124 of the robot(s) 110. The control data 122 may then be sent to the motor(s) 124 of the robot(s) 110 to cause the motor(s) 124 to rotate and/or actuate to update a pose of the robot(s) 110 to correspond to a pose of the user. One or more camera(s) 126 of the robot(s) 110 may generate image data 128 representing images depicting a first-person perspective view associated with the robot(s) 110, and the streaming component 112 may stream the image data 128 to the spatial computing device(s) 104 for presentation using one or more displays 130. Thus, in summary, the process 100 may be performed for a user (e.g., teleoperator) to control the operations of the robot(s) 110, where the robot(s) 110 are controlled to replicate the poses of the user captured in the sensor data, and video associated with the live actions of the robot(s) 110 are streamed back to the user for real-time or near real-time feedback.

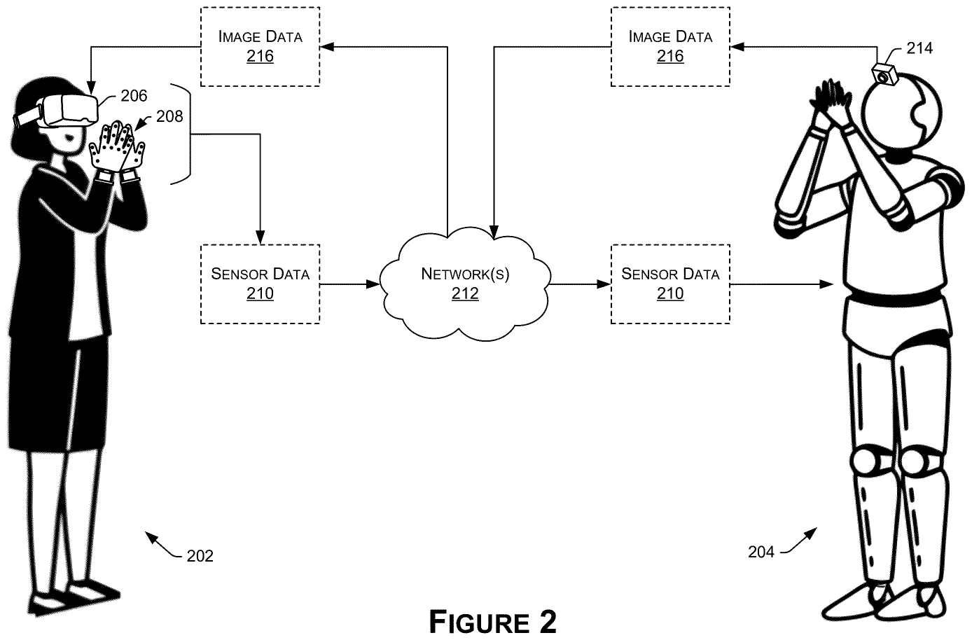

For instance, FIG. 2 illustrates an example of a teleoperator 202 (e.g., a user) remotely controlling a humanoid robot 204, in accordance with some embodiments of the present disclosure. The humanoid robot 204 may, in some instances, correspond to the robot(s) 110 from the example of FIG. 1. As shown, the teleoperator 202 may be wearing a spatial computing device 206, which may correspond to the spatial computing device(s) 104, and a set of motion sensing gloves 208, which may correspond to or include the sensor(s) 102. The teleoperator 202 may control the operations and/or movements of the humanoid robot 204 by physically performing (e.g., acting out) the operations/movements that the teleoperator 202 desires or intends for the humanoid robot 204 to carry out. For instance, as the teleoperator 202 makes various poses, gestures, or other movements, the spatial computing device 206 and the motion sensing gloves 208 may generate sensor data 210 that is sent over one or more networks 212 (e.g., Bluetooth, Wi-Fi, a local area network (LAN) connection, a wide area network (WAN) connection, and/or any other networks) to the humanoid robot 204. One or more systems of the humanoid robot 204 may use the sensor data 210 to control the movements of the humanoid robot 204. Additionally, the humanoid robot 204 may include a camera 214 (which may correspond to the camera(s) 126) that generates image data 216 that is sent back to the spatial computing device 206 via the network(s) 212. The image data 216 may represent a video depicting a first-person perspective view associated with the humanoid robot 204, and the video may be live streamed to the teleoperator 202 for feedback so that the teleoperator 202 may, among other things, see what the robot is doing at its respective location responsive to various inputs (e.g., motions, poses, etc.).

Referring back to the example of FIG. 1, the process 100 may include the pose component 106 obtaining the sensor data 116 generated using the sensor(s) 118 of the spatial computing device(s) 104. As described herein, in some examples, the spatial computing device(s) 104 may include, but is not limited to, an AR headset, a VR headset, or an MR headset. In some examples, the sensor(s) 118 may include, but are not limited to, one or more cameras (e.g., RGB cameras, depth cameras, infrared (IR) cameras), one or more inertial measurement units (IMUs) (e.g., accelerometers, gyroscopes, magnetometers), one or more LiDAR sensors, one or more ultrasonic sensors, one or more geolocation sensors (e.g., GPS), or any other kinds of sensors. In some examples, the spatial computing device(s) 104 may be capable of tracking the movements and/or three-dimensional (3D) locations of the user's hands, fingers, wrists, arms, legs, feet, toes, shoulders, abdomen, neck, head, or any other body parts of the user. In some instances, the sensor data 116 may be indicative of one or more first poses associated with one or more first portions of the user. For instance, the sensor data 116 generated using the sensor(s) 118 may indicate poses, movements, joint angles, etc. of the user's non-manual body parts (e.g., head, neck, abdomen, shoulders, arms, hips, legs, knees, feet, toes). However, this is just an example, and in some instances the sensor data 116 may be indicative of movements, poses, etc. of the user's entire body (e.g., manual and non-manual body parts).

Additionally, in some examples, the pose component 106 may obtain the sensor data 114 generated using the sensor(s) 102. For example, the sensor(s) 102 may be associated with motion tracking gloves (such as the motion tracking gloves 208) worn by the user, or another wearable tracking device wearable by the user. As described herein, in some examples, the sensor(s) 102 of the motion tracking gloves may be configured to sense motion of the user's hand-related or manual body parts (e.g., hands, wrist, fingers, thumbs, etc.). As such, the sensor data 114 generated using the sensor(s) 102 may be indicative of one or more second poses associated with one or more second portions of the user, which may be different than the first portion(s) of the user. In some examples, different portions of the sensor data 114 may be generated using different sensors of the sensor(s) 102. For instance, one or more first portions of the sensor data 114 may be generated using one or more finger tracking sensors of the sensor(s) 102, one or more second portions of the sensor data 114 may be generated using one or more hand tracking sensors of the sensor(s) 102, one or more third portions of the sensor data 114 may be generated using one or more wrist tracking sensors of the sensor(s) 102, and so forth.

In some examples, such as when the sensor(s) 102 are part of a motion tracking glove system, the sensor(s) 102 may include one or more IMU sensors (e.g., accelerometers, gyroscopes, magnetometers) which may be used to track the orientation, angular velocity, and/or linear acceleration of the user's hand, and/or provide real-time data on the position and movement of the gloves in 3D space, one or more flex sensors (e.g., resistive and/or fiber-optic sensors) for measuring the degree of bending or flexion of each finger and/or providing precise tracking of finger joint movements, one or more force sensors (e.g., pressure-sensitive pads or piezoelectric sensors) for measuring the force or pressure applied by the user's fingertips and/or palms, and/or any other kinds of sensors for tracking the movements of the user's hand complexes.

In some instances, the process 100 may include the pose component 106 using the sensor data 114 and 116 to determine poses (e.g., 3D position and/or 3D orientation, joint angles, etc.) associated with the various different portions or body parts of the user. The poses determined by the pose component 106 may be represented using the pose data 120. For instance, based at least on the sensor data 116 the pose component 106 may determine one or more first poses associated with the user's non-manual body parts. As an example, using the sensor data 116 the pose component 106 may determine, among other things, respective joint angles associated with the user's shoulder joints, elbow joints, hip joints, knee joints, ankle joints, neck, or any other joints of the user. That is, the pose component 106 may use the sensor data 116, which may be associated with a particular point in time (e.g., frame, timestep, etc.), to determine the pose of certain body parts of the user at that particular point in time. In some instances, the poses for certain body parts or joints may be multi-dimensional. For example, a shoulder joint may have multiple angles or use a 3D-coordinate system to describe the pose or joint angle, whereas an elbow joint may have a single angle associated with it (e.g., between 0 and 180-degrees).

Similarly, based at least on the sensor data 114 and/or the sensor data 116, the pose component 106 may determine one or more poses associated with the user's manual body parts (e.g., wrists, hands, fingers, thumbs, etc.). As an example, using the sensor data 114 (and/or 116) the pose component 106 may determine individual poses made by each one of the user's fingers, thumbs, hands, and/or wrists. That is, the pose component 106 may use the sensor data 114, which may be associated with a particular point in time, to determine the poses of the user's hands, fingers, thumbs, and/or wrists at that particular point in time.

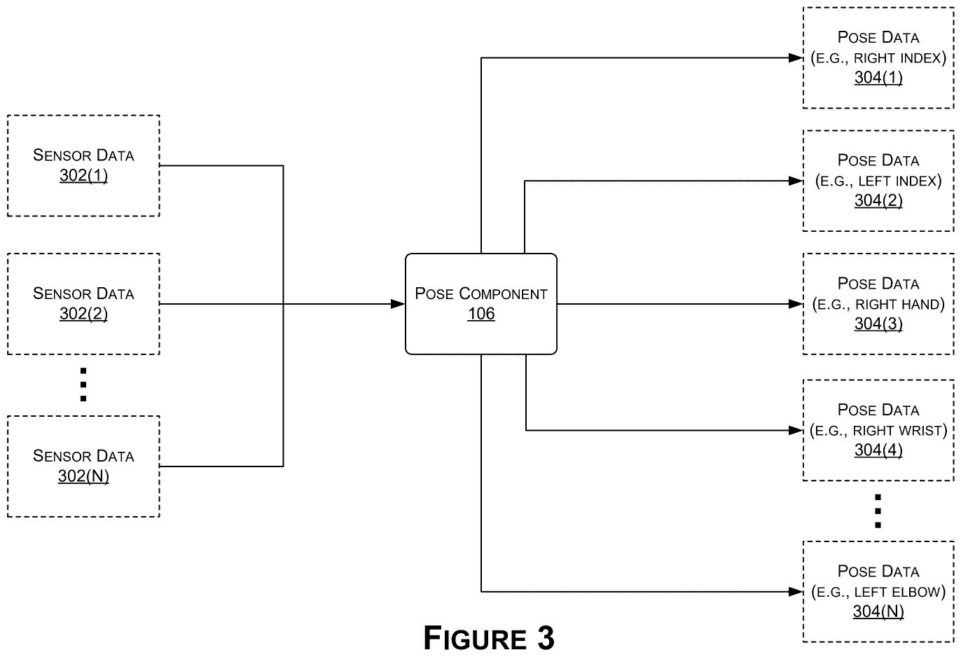

For instance, FIG. 3 illustrates example detail associated with using various sensor data inputs to determine a plurality of poses associated with a teleoperator, in accordance with some embodiments of the present disclosure. As illustrated in the example of FIG. 3, the pose component 106 may receive multiple instances of sensor data from one or more modalities of sensors. For instance, the first sensor data 302(1) may correspond to the sensor data 114 received from the sensor(s) 102, the second sensor data 302(2) may correspond to the sensor data 116 received from the spatial computing device(s) 104, and the Nth sensor data 302(N) may represent sensor data obtained from one or more other sensors, where “N” may represent any number of instances of the sensor data 302. The pose component 106 may then use the sensor data 302 to determine independent poses of various body parts of the user, which may be represented using the pose data 304(1)-304(N). For instance, the pose component 106 may generate first pose data 304(1) which may be indicative of a pose of the user's right index finger, generate second pose data 304(2) which may be indicative of a pose of the user's left index finger, generate third pose data 304(3) which may be indicative of a pose of the user's right hand, and so forth.

In some examples, the pose component 106 may use individual instances of the sensor data 302 to determine individual poses, and/or use a combination of the instances of the sensor data 302 to determine the individual poses. For example, the pose component 106 may use the first sensor data 302(1) to generate the first pose data 304(1), the second sensor data 302(2) to generate the second pose data 304(1), and use a combination of the first sensor data 302(1) and the second sensor data 302(2) to generate the third pose data 304(3). As another example, the pose component 106 may use a first portion of the first sensor data 302(1) to generate the first pose data 304(1), a second portion of the first sensor data 302(1) to generate the second pose data 304(2), a first portion of the second sensor data 302(2) to generate the third pose data 304(3), a second portion of the second sensor data 302(2) to generate the fourth pose data 304(4), etc.

Additionally, in some examples, the pose component 106 may select the best sensor data source to use for determining the pose of the user based on one or more factors. For example, if the pose of the user results in the user's hand(s) being occluded from view of the spatial computing device, the pose component 106 may associate a higher confidence score with the sensor data from the motion tracking gloves and use that sensor data to determine the pose of the user's hand(s). Additionally, in some examples, the pose component 106 may use both the motion tracking gloves and the spatial computing device to track the motion or poses of the same portions of the user, and average or interpolate between different sensor data measurements to determine the pose(s) of the user with greater accuracy, redundancy, etc.

Referring back to the example of FIG. 1, the process 100 may include the retargeting component 108 receiving the pose data 120 and generating control data 122 to send to the motor(s) 124 of the robot(s) 110. As described herein, in some examples, the retargeting component 108 may determine a plurality of rotation angles for the motor(s) 124 of the robot(s) 110. For instance, based at least on the pose data 120, the retargeting component 108 may determine one or more first rotation angles for one or more first motors that control one or more first components of the robot(s) 110. In various instances, the first component(s) may correspond to the first portion(s) of the user. In other words, using the pose data 120, the retargeting component 108 may determine how much that each one of the first motor(s) needs to rotate or actuate in order to cause the robot(s) 110 to mirror the poses, movements, joint angles, etc. of the first portion(s) of the user. As one example, if the pose data 120 indicates that a joint angle of the user's right knee is 45-degrees, the retargeting component 108 may determine how much a motor(s) that controls the right knee of the robot(s) 110 needs to rotate or actuate to cause the right knee of the robot to bend to 45-degrees.

Similarly, based at least on the pose data 120, the retargeting component 108 may determine one or more second rotation angles for one or more second motors that control one or more second components of the robot(s) 110. In various instances, the second component(s) may correspond to the second portion(s) of the user. In other words, using the pose data 120 the retargeting component 108 may determine how much that each one of the second motor(s) needs to rotate or actuate in order to cause the second component(s) of the robot(s) 110 to mirror the poses, movements, joint angles, etc. made by the second portion(s) of the user. As another example, if the pose data 120 indicates that a joint angle of the user's right index finger metacarpophalangeal joint (the joint at the base of the index finger where it meets the hand) is 15-degrees, the retargeting component 108 may determine how much a motor(s) that controls the right index finger of the robot(s) 110 needs to rotate or actuate to make the right index finger of the robot(s) 110 correspond to the user's finger. In some examples, to map the poses of the user to the rotation angles for the motor(s) 124 of the robot(s) 110, the retargeting component 108 may apply the values in the sensor data or the pose data 120 to one or more functions. For instance, the retargeting component 108 may use one or more inverse kinematics functions and/or other functions to determine the target rotation angles for each motor based on the sensor data.

In various examples, the retargeting component 108 may generate control data 122 representing control signals for controlling the motor(s) 124 of the robot(s) 110, and send these signals to the motor(s) 124 to actuate them and update the pose of the robot(s) 110. For instance, based on determining the target rotation angles of the motor(s) 124, the retargeting component 108 may determine the control signals and generate the control data 122 to cause the motor(s) 124 to rotate in accordance with the target rotation angles. That is, by causing the motor(s) 124 to rotate or actuate, the motor(s) 124 may move the components/human-like features of the robot(s) 110 so that the pose of the robot(s) 110 corresponds to the pose of the user.

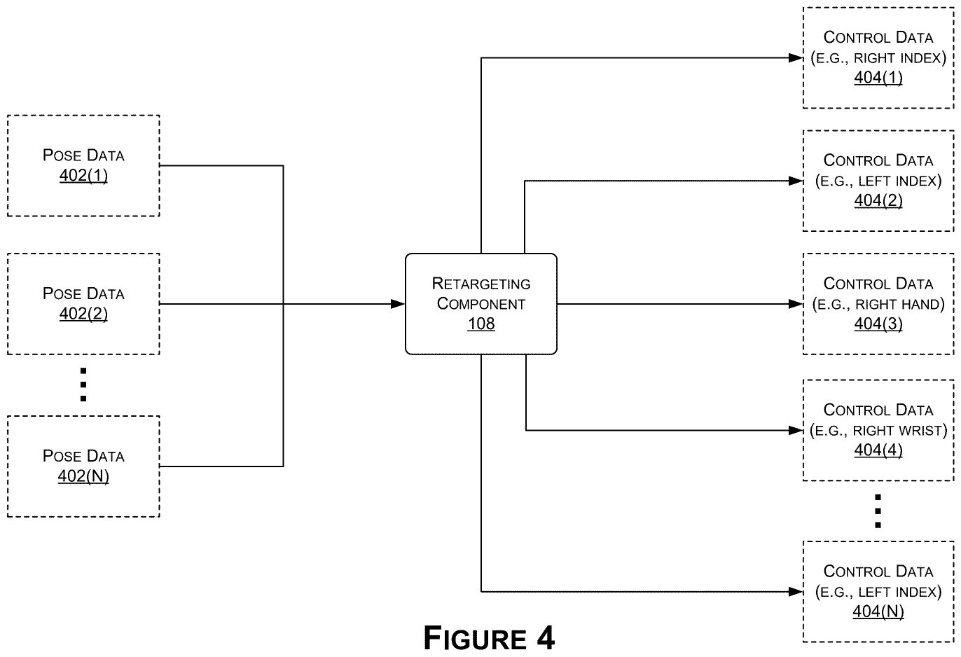

For instance, FIG. 4 illustrates example detail associated with mapping various poses to control inputs to apply to motors or actuators of a robot, in accordance with some embodiments of the present disclosure. As illustrated in the example of FIG. 4, the retargeting component 108 may receive multiple instances of pose data 402(1)-402(N), which may be indicative of different poses of different portions of the user. For instance, the first pose data 402(1) may be indicative of a first pose associated with a first portion of the user (e.g., first body part(s), first joint angle(s), etc.), the second pose data 402(2) may be indicative of a second pose associated with a second portion of the user (e.g., second body part(s), second joint angle(s), etc.), and so forth. In some instances, the first pose data 402(2) may correspond to a first portion of the pose data 120, the second pose data 402(2) may correspond to a second portion of the pose data 120, and so forth.

In some examples, the retargeting component 108 may then use the pose data 402 to determine independent control inputs to apply to each of the motors of the robot to make the robot replicate the pose of the user. For instance, the retargeting component 108 may generate first control data 404(1) indicative of a first control input to be applied to a first motor of the robot, second control data 404(2) indicative of a second control input to be applied to a second motor of the robot, third control data 404(3) indicative of a third control input to be applied to a third motor of the robot, and so forth. In some examples, the retargeting component 108 may use individual instances of the pose data 402 to determine individual control inputs, and/or use a combination of the instances of the pose data 402 to determine the individual poses. For example, the retargeting component 108 may use the first pose data 402(1) to generate the first control data 404(1), the second pose data 402(2) to generate the second control data 404(1), and use a combination of the first pose data 402(1) and the second pose data 402(2) to generate the third control data 404(3).

Referring back to the example of FIG. 1, the process 100 may include applying the control data 122 to the motor(s) 124 of the robot(s) 110. By applying the control data 122 to the motor(s) 124, the robot(s) 110 may perform a pose that replicates the pose of the user for the same timestep as the sensor data 114 and/or 116. In some examples, the camera(s) 126 may generate image data 128 representing an image(s) depicting a first-person perspective view associate with the robot(s) 110. The streaming component 112 may use the image data 128 to stream a video depicting the first-person perspective view associated with the robot back to the user controlling the robot. For instance, the camera(s) 126 may be mounted on the robot(s) 110 and the video/image data 128 may depict a view of the environment surrounding the robot(s) 110 as seen through the “eyes” of the robot(s) 110. In such examples, the streaming component 112 may live stream the image data 128 back to the spatial computing device(s) 104, which may be worn upon the user's head, and the image data 128 may be displayed using the display(s) 130 of the spatial computing device(s) 104 so that the user can see what the robot(s) 110 is doing responsive to the user's motions.

In various examples, the different aspects of the process 100 may be continuously repeated (e.g., in a loop), and the poses of the robot(s) 110 may be continuously updated to replicate the poses of the user. By continuously performing the process 100, the robot(s) 110 may perform complex actions, tasks, and/or any other poses performed by the user, such as running, walking, jumping, sitting down, lifting objects, assembling products, writing, shaking hands, or any other user-performed motions. In other words, the process 100, or aspects thereof, may be repeated multiple times/cycles throughout a period of time, and the pose of the robot may be incrementally updated each time based on minor changes in the poses of the user during the period of time. For instance, the process may be performed multiple times in a second to enable the robot(s) 110 to have realistic, human-like movement that corresponds to the movements of the user (e.g., teleoperator).

In some examples, the system(s) may use the image data 128, as well as the actions performed by the user, for AI policy training of humanoid robots and/or other types of robotic systems. For instance, the data may be processed to identify specific patterns, gestures, or sequences of movements performed by the user, which can then be translated into actionable commands or behavioral models for the robot(s) 110. These models may enable the robot(s) 110 to mimic human actions, adapt to complex environments, or perform tasks with greater precision and autonomy. By analyzing user interactions and contextual cues, the systems of the present disclosure may refine the training process, improving the decision-making capabilities of the robot(s) 110 and task execution over time. This approach may also facilitate transfer learning, where knowledge gained from one task is applied to another, enhancing the versatility of robotic systems in various real-world applications.

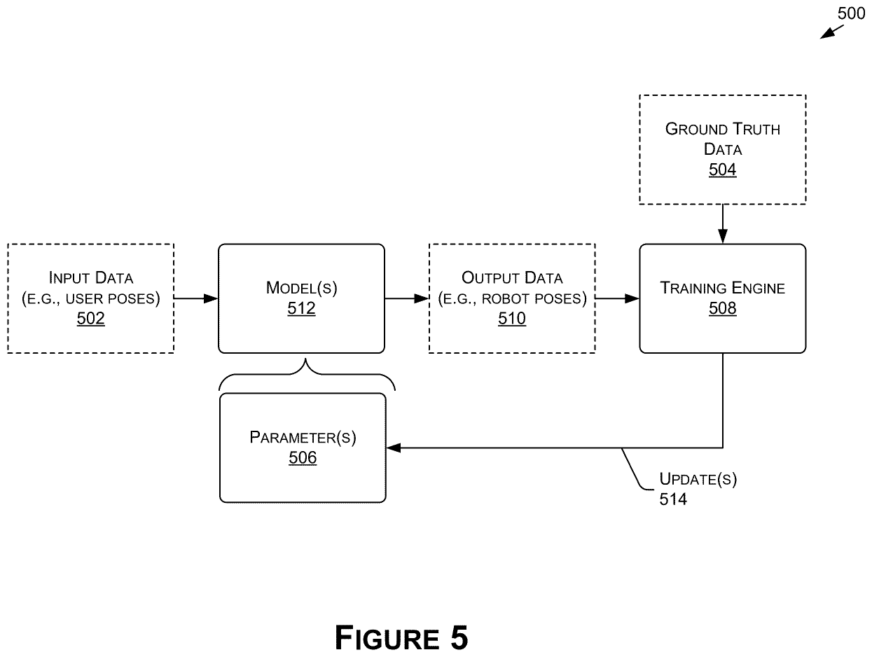

For instance, FIG. 5 is a data flow diagram illustrating an example process 500 for policy training one or more models, in accordance with some embodiments of the present disclosure. As shown, the model(s) 512 (which may correspond to one or more machine learning models, one or more algorithmic models, or any other type of models) may be trained using input data 502 (e.g., user motions and/or poses) as well as ground truth data 504 (which may correspond to the input data 502). For instance, based on the input data 502 the model(s) 512 may control the robot to perform various poses indicated by the output data 510, and differences between the user-performed poses and the robot-performed poses may be used to perform one or more updates 514 to one or more parameters 506 of the model(s) 512. In some examples, the ground truth data 504 may correspond to or represent an updated version of the input data 502.

A training engine 508 may use one or more loss functions that measure loss (e.g., error) in the output data 510 generated by the model(s) 512 as compared to the ground truth data 504 and/or the input data 502. In some examples, the training engine 508 may compare the output data 510 from the model(s) 512 to the input data 502, and update 514 one or more parameters 506 of the model(s) 512 based at least on the comparing. That is, the training engine 508 may update/optimize one or more parameters 506 associated with the model(s) 512 to reduce the losses/differences between the output data 510 and the ground truth data 504. Any type of loss function may be used, such as cross entropy loss, mean squared error, mean absolute error, mean bias error, and/or other loss function types. In some examples, different outputs may have different loss functions. In such examples, the loss functions may be combined to form a total loss, and the total loss may be used to train (e.g., update the parameters of) the model(s) 512. In any example, backward pass computations may be performed to recursively compute gradients of the loss function(s) with respect to training parameters. In some examples, weight and biases of the model(s) 512 may be used to compute these gradients.

In some examples, the model(s) 512 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the model(s) 512 is small enough (e.g., has a small enough number of parameters), the model(s) 512 may be included within the container itself. In some embodiments, the model(s) 512 described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The model(s) 512 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) 512 (e.g., that has been optimized for high performance inference), an inference runtime software to execute the model(s) 512 and provide outputs/responses to inputs (e.g., user queries, prompts, etc.), and enterprise management software to provide health checks, identity, and other monitoring. In some embodiments, the inference microservice may include software to perform in-place replacement and/or updating to the model(s) 512. When replacing or updating, the software that performs the replacement/updating may maintain user configurations of the inference runtime software and enterprise management software.

By way of example, and without limitation, any of the various machine learning models and/or neural networks described herein (e.g., the model(s) 512) may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

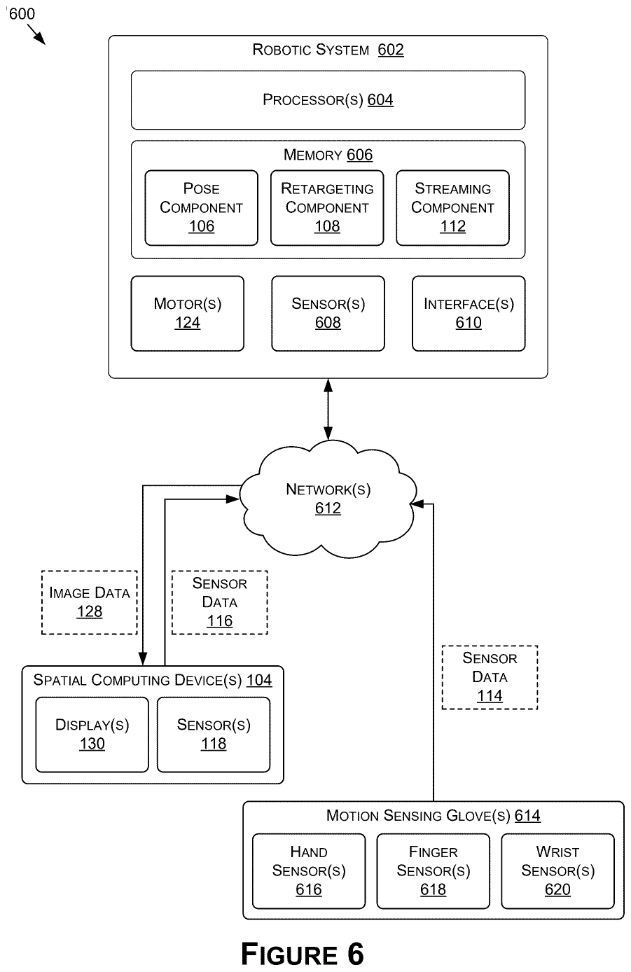

Referring now to FIG. 6, FIG. 6 illustrates an example of a system 600 that may perform one or more of the processes described herein, in accordance with some embodiments of the present disclosure. As shown, the system 600 may include a robotic system 602 (which may represent, and/or include, the robot(s) 110, the example computing device(s) 900, and/or the example data center 1000) that includes one or more processors 604 (which may be similar to, and/or include, the CPUs 906 and/or the GPUs 908) and memory 606 (which may be similar to, and/or include, the memory 904). For instance, the memory 606 may store one or more of the pose component 106, the retargeting component 108, and/or the streaming component 112. Additionally, the processor(s) 604 may execute one or more of the pose component 106, the retargeting component 108, and/or the streaming component 112 to perform one or more of the processes described herein. The robotic system 602 may also include the motor(s) 124, one or more sensors 608 (which may correspond to or include the camera(s) 126), and one or more interfaces 610. The interface(s) 610 may enable the robotic system 602 to communicate over one or more networks 612 with the spatial computing device(s) 104 and/or one or more motion sensing gloves 614 (which may correspond to the sensor(s) 102). The motion sensing glove(s) 614 may include one or more hand sensors 616, one or more finger sensors 618, and/or one or more wrist sensors 620.

In some examples, the system 602 may receive the sensor data 114 and/or 116 from the motion sensing glove(s) 614 and/or the spatial computing device(s) 104. The robotic system 602 may then use the sensor data to cause the motor(s) 124 to update a pose of the robotic system 602. For instance, the robotic system 602 may correspond to a humanoid robot, and the motor(s) 124 may control the humanlike features of the humanoid robot to replicate the pose of a user or teleoperator (e.g., one associated with the spatial computing device(s) 104 and/or wearing the motion sensing glove(s) 614). In some examples, the sensor(s) 608 may generate image data 128 that is streamed, over the network(s) 612, back to the spatial computing device(s) 104 by the robotic system 602. This may allow the remote user to see what the robotic system 602 is doing, where it is located, objects it is handling, how the system is responding to certain poses/inputs, etc.

Now referring to FIG. X, each block of method X00, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method X00 is described, by way of example, with respect to the system of FIG. 1. However, this method may additionally or alternatively be executed by any one system, or any combination of systems, including, but not limited to, those described herein.

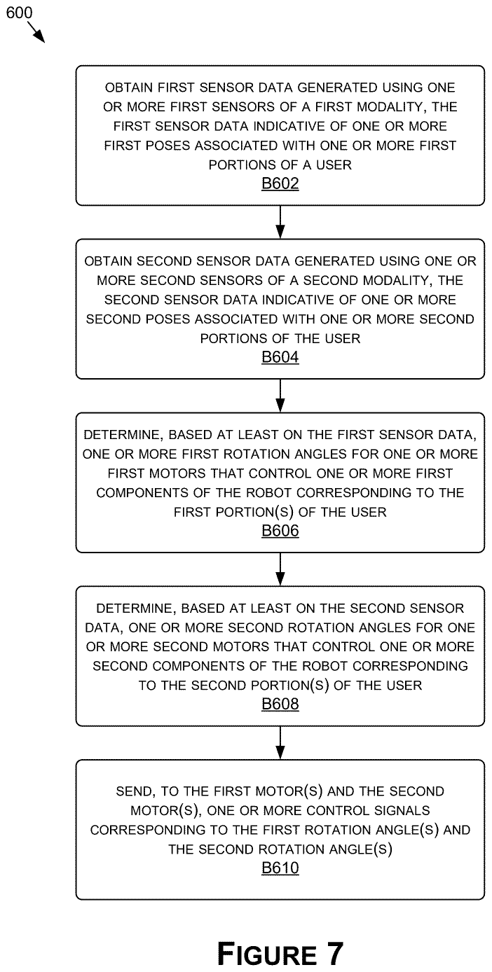

FIG. 7 is a flow diagram illustrating an example of a method 700 for using sensor data from different modalities of sensors to control different components of a robot, in accordance with some embodiments of the present disclosure. The method 700, at block B702, includes obtaining first sensor data generated using one or more first sensors of a first modality, the first sensor data indicative of one or more first poses associated with one or more first portions of a user. For instance, the pose component 106 may obtain the sensor data 116 generated using the sensor(S) 118 of the spatial computing device(s) 104. In some examples, the first sensor data may be indicative of one or more first poses associated with one or more first portions of a user, such as the user's non-manual body parts (e.g., head, neck, arms, elbows, shoulders, torso, hips, legs, knees, and/or ankles).

The method 700, at block B704, includes obtaining second sensor data generated using one or more second sensors of a second modality, the second sensor data indicative of one or more second poses associated with one or more second portions of the user. For instance, the pose component 106 may obtain the sensor data 114 generated using the sensor(s) 102 (which may be part of the motion sensing glove(s) 614). In some examples, the second sensor data may be indicative of one or more second poses associated with one or more second portions of the user, such as the user's manual body parts or hand complexes (e.g., wrists, hands, fingers, thumbs, and/or joints associated with those body parts).

The method 700, at block B706, includes determining, based at least on the first sensor data, one or more first rotation angles for one or more first motors that control one or more first components of the robot corresponding to the first portion(s) of the user. For instance, the retargeting component 108 may determine, based at least on the first sensor data, the first rotation angle(s) for the first motor(s) that control the first component(s) of the robot(s) 110 corresponding to the first portion(s) of the user.

The method 700, at block B708, includes determining, based at least on the second sensor data, one or more second rotation angles for one or more second motors that control one or more second components of the robot corresponding to the second portion(s) of the user. For instance, the retargeting component 108 may determine, based at least on the second sensor data, the second rotation angle(s) for the second motor(s) that control the second component(s) of the robot(s) 110 corresponding to the second portion(s) of the user.

The method 700, at block B710, includes sending, to the first motor(s) and the second motor(s), one or more control signals corresponding to the first rotation angle(s) and the second rotation angle(s). For instance, the control data 122 representing the control signal(s) corresponding to the first rotation angle(s) and the second rotation angle(s) may be sent to the motor(s) 124 of the robot(s) 110. The control signal(s) may then cause the motor(s) 124 to actuate and update the pose of the robot(s) 110 to correspond to the pose of the user.

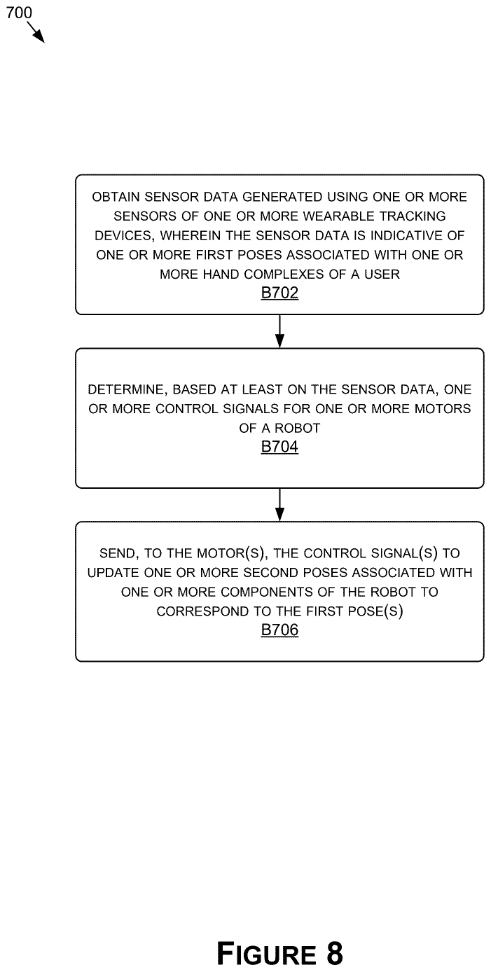

FIG. 8 is a flow diagram illustrating an example of a method 800 for controlling a robot to replicate motions or poses of a user, in accordance with some embodiments of the present disclosure. The method 800, at block B802, includes obtaining sensor data generated using one or more sensors of one or more wearable tracking devices, wherein the sensor data is indicative of one or more first poses associated with one or more hand complexes of a user. For instance, the pose component 106 may obtain the sensor data 114 and/or 116 generated using the sensor(s) 102 and/or the sensor(s) 118 of the wearable tracking device(s) (e.g., a spatial computing device (AR, VR, MR headset), motion tracking gloves, etc.). In some examples, the sensor data 114 and/or 116 may be indicative of the first pose(s) associated with the hand complex(es) of the user.

The method 800, at block B804, includes determining, based at least on the sensor data, one or more control signals for one or more motors of a robot. For instance, the retargeting component 108 may determine the control signal(s) and generate the control data 122 representative of the control signal(s). In some examples, the control signals may be determined based on pose data, such as the pose data 120 generated using the pose component 106 to process the sensor data 114 and/or 116, and the pose data may indicate the first pose(s) of the user.

The method 800, at block B806, includes sending, to the motor(s), the control signal(s) to update one or more second poses associated with one or more components of the robot to correspond to the first pose(s). For instance, the control data 122 representative of the control signal(s) may be sent to the motor(s) 124 of the robot(s) 110, and the control data 122 may cause the motor(s) 124 to rotate or actuate to update the second pose(s) associated with the component(s) of the robot(s) 110 to correspond to the first pose(s). That is, the control signals may cause the motor(s) of the robot(s) 110 to move so that the human-like features of the robot make the same or similar pose as the same features/body parts of the user.

### Example Computing Device

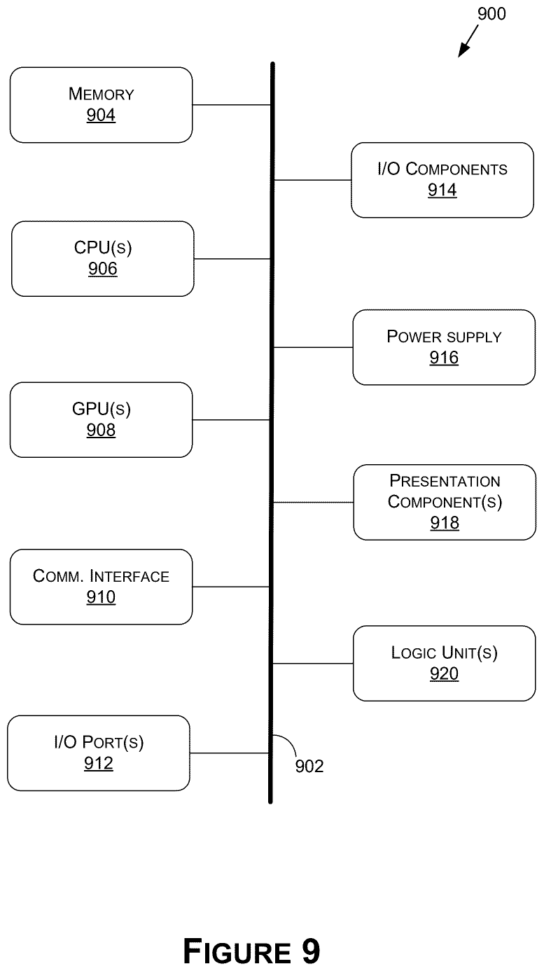

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

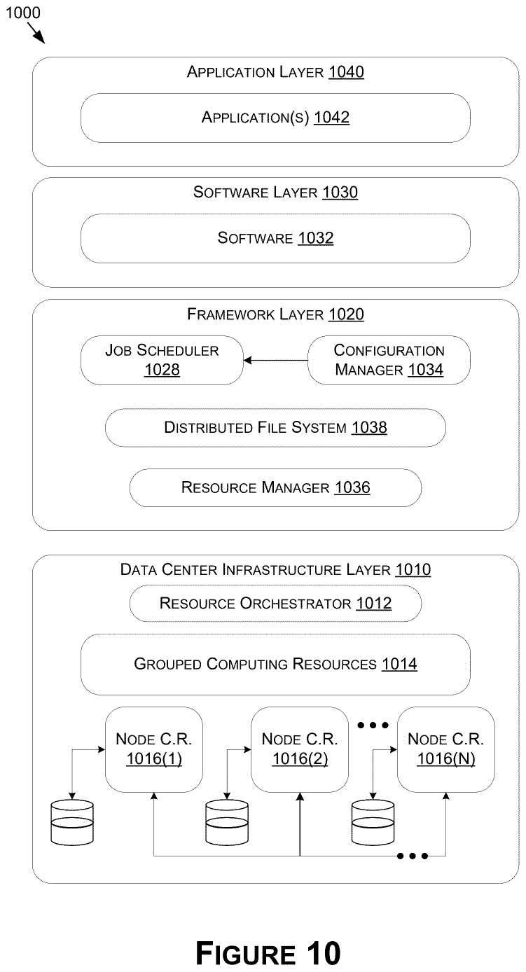

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R. s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Example Paragraphs
A. A method comprising: obtaining first sensor data generated using one or more first sensors of a first modality, the first sensor data indicative of one or more first poses associated with one or more first portions of a user; obtaining second sensor data generated using one or more second sensors of a second modality, the second sensor data indicative of one or more second poses associated with one or more second portions of the user; determining, based at least on the first sensor data, one or more first rotation angles for one or more first motors that control one or more first components of a robot, the one or more first components corresponding to the one or more first portions of the user; determining, based at least on the second sensor data, one or more second rotation angles for one or more second motors that control one or more second components of the robot, the one or more second components corresponding to the one or more second portions of the user; sending, to the one or more first motors and the one or more second motors, one or more control signals corresponding to the one or more first rotation angles and the one or more second rotation angles; obtaining image data representing a video depicting a first-person perspective view associated with the robot; updating, based at least on the image data and the one or more control signals, an artificial intelligence (AI) policy associated with the robot; and training, using the AI policy, one or more second robots.
B. The method of paragraph A, wherein: the one or more first poses are indicative of one or more first joint angles associated with the one or more first portions of the user, and the one or more second poses are indicative of one or more second joint angles associated with the one or more second portions of the user.
C. The method of any one of paragraphs A-B, wherein: the one or more first sensors of the first modality include one or more spatial computing devices, and the one or more second sensors of the second modality include one or more wearable tracking devices.
D. The method of any one of paragraphs A-C, wherein the one or more wearable tracking devices include, at least: one or more finger tracking sensors; one or more hand tracking sensors; and one or more wrist tracking sensors.
E. The method of any one of paragraphs A-D, further comprising: mapping, based at least on applying the first sensor data to one or more first functions, the one or more first poses to the one or more first rotation angles; and mapping, based at least on applying the second sensor data to one or more second functions, the one or more second poses to the one or more second rotation angles.
F. The method of any one of paragraphs A-E, wherein: the one or more first portions of the user include at least one of a head, a neck, a torso, or a lower extremity of the user, and the one or more second portions of the user include at least one of an arm, a wrist, a hand, or a finger of the user.
G. The method of any one of paragraphs A-F, further comprising: obtaining a stream of the image data representing the video depicting the first-person perspective view associated with the robot, the stream of image data generated using one or more image sensors of the robot; and causing display of the video using a display screen associated with the one or more first sensors.
H. A system comprising: one or more processors to: obtain sensor data generated using one or more sensors of one or more wearable tracking devices, wherein the sensor data is indicative of one or more first poses associated with one or more hand complexes of a user; determine, based at least on the sensor data, one or more control signals for one or more motors of a robot; and send, to the one or more motors, the one or more control signals to update one or more second poses associated with one or more components of the robot to correspond to the one or more first poses.
I. The system of paragraph H, the one or more processors to: determine, based at least on the sensor data, one or more rotation angles associated with the one or more motors to update the one or more second poses, wherein the determination of the one or more control signals is based at least on the one or more rotation angles.
J. The system of any one of paragraphs H-I, wherein: the sensor data is indicative of respective poses of independent fingers of the user, and the one or more control signals independently control movements of independent robotic fingers of the robot that correspond to the independent fingers of the user.
K. The system of any one of paragraphs H-J, wherein the obtainment of the sensor data comprises: obtaining a first portion of the sensor data from one or more finger tracking sensors of the one or more wearable tracking devices; obtaining a second portion of the sensor data from one or more hand tracking sensors of the one or more wearable tracking devices; and obtaining a third portion of the sensor data from one or more wrist tracking sensors of the one or more wearable tracking devices.
L. The system of any one of paragraphs H-K, the one or more processors further to: obtain a stream of image data representing a video depicting a first-person perspective view associated with the robot, the stream of image data generated using one or more image sensors of the robot; update, based at least on the image data and the one or more control signals, an artificial intelligence (AI) policy associated with the robot; and train, using the AI policy, one or more second robots.
M. The system of any one of paragraphs H-L, the one or more processors further to: determine, using the sensor data, the one or more first poses associated with the one or more hand complexes of the user, wherein the one or more first poses are indicative of at least one of: one or more locations associated with one or more joints of the one or more hand complexes in three-dimensional (3D) space, one or more orientations, in the 3D space, of one or more portions of the one or more hand complexes, or one or more joint angles associated with the one or more portions of the one or more hand complexes.
N. The system of any one of paragraphs H-M, the one or more processors further to: obtain second sensor data generated using one or more second sensors of one or more spatial computing devices, wherein the second sensor data is indicative of one or more third poses associated with one or more non-manual body parts of the user; determine, based at least on the second sensor data, one or more second control signals for one or more second motors of the robot; and send, to the one or more second motors, the one or more second control signals.
O. The system of any one of paragraphs H-N, the one or more processors further to: determine, based at least on the sensor data, one or more joint angles associated with one or more portions of the one or more hand complexes, wherein the determination of the one or more control signals is further based at least on the one or more joint angles.
P. The system of any one of paragraphs H-O, wherein: the robot is a humanoid robot, the one or more components are associated with one or more second hand complexes of the humanoid robot that correspond to the one or more hand complexes of the user, and the one or more motors control movement of the one or more components.
Q. The system of any one of paragraphs H-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models (MMLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
R. One or more processors comprising: processing circuitry to perform one or more movements of a humanoid robot, wherein an artificial intelligence (AI) of the humanoid robot is trained to perform the one or more movements, at least, by obtaining sensor data from a plurality of sensors of different modalities, the plurality of sensors including at least one or more spatial computing devices for tracking motion of one or more non-manual portions of a user and one or more wearable tracking devices for tracking motion of one or more hand complexes of the user.
S. The one or more processors of paragraph R, the processing circuitry further to: control, based at least on first sensor data obtained using the one or more spatial computing devices, one or more first movements of one or more first components of the humanoid robot that correspond to the one or more non-manual portions of the user; and control, based at least on second sensor data obtained using the one or more wearable tracking devices, one or more second movements of one or more second components of the humanoid robot that correspond to the one or more hand complexes of the user.
T. The one or more processors of any one of paragraphs R-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models (MMLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining first sensor data generated using one or more first sensors of a first modality, the first sensor data indicative of one or more first poses associated with one or more first portions of a user;
obtaining second sensor data generated using one or more second sensors of a second modality, the second sensor data indicative of one or more second poses associated with one or more second portions of the user;
determining, based at least on the first sensor data, one or more first rotation angles for one or more first motors that control one or more first components of a robot, the one or more first components corresponding to the one or more first portions of the user;
determining, based at least on the second sensor data, one or more second rotation angles for one or more second motors that control one or more second components of the robot, the one or more second components corresponding to the one or more second portions of the user;
sending, to the one or more first motors and the one or more second motors, one or more control signals corresponding to the one or more first rotation angles and the one or more second rotation angles;
obtaining image data representing a video depicting a first-person perspective view associated with the robot;
updating, based at least on the image data and the one or more control signals, an artificial intelligence (AI) policy associated with the robot; and
training, using the AI policy, one or more second robots.

2. The method of claim 1, wherein:
the one or more first poses are indicative of one or more first joint angles associated with the one or more first portions of the user, and
the one or more second poses are indicative of one or more second joint angles associated with the one or more second portions of the user.

3. The method of claim 1, wherein:
the one or more first sensors of the first modality include one or more spatial computing devices, and
the one or more second sensors of the second modality include one or more wearable tracking devices.

4. The method of claim 3, wherein the one or more wearable tracking devices include, at least:
one or more finger tracking sensors;
one or more hand tracking sensors; and
one or more wrist tracking sensors.

5. The method of claim 1, further comprising:
mapping, based at least on applying the first sensor data to one or more first functions, the one or more first poses to the one or more first rotation angles; and
mapping, based at least on applying the second sensor data to one or more second functions, the one or more second poses to the one or more second rotation angles.

6. The method of claim 1, wherein:
the one or more first portions of the user include at least one of a head, a neck, a torso, or a lower extremity of the user, and
the one or more second portions of the user include at least one of an arm, a wrist, a hand, or a finger of the user.

7. The method of claim 1, further comprising:
obtaining a stream of the image data representing the video depicting the first-person perspective view associated with the robot, the stream of image data generated using one or more image sensors of the robot; and
causing display of the video using a display screen associated with the one or more first sensors.

8. A system comprising:
one or more processors to:
obtain sensor data generated using one or more sensors of one or more wearable tracking devices, wherein the sensor data is indicative of one or more first poses associated with one or more hand complexes of a user;
determine, based at least on the sensor data, one or more control signals for one or more motors of a robot; and
send, to the one or more motors, the one or more control signals to update one or more second poses associated with one or more components of the robot to correspond to the one or more first poses.

9. The system of claim 8, the one or more processors to:
determine, based at least on the sensor data, one or more rotation angles associated with the one or more motors to update the one or more second poses,
wherein the determination of the one or more control signals is based at least on the one or more rotation angles.

10. The system of claim 8, wherein:
the sensor data is indicative of respective poses of independent fingers of the user, and
the one or more control signals independently control movements of independent robotic fingers of the robot that correspond to the independent fingers of the user.

11. The system of claim 8, wherein the obtainment of the sensor data comprises:
obtaining a first portion of the sensor data from one or more finger tracking sensors of the one or more wearable tracking devices;
obtaining a second portion of the sensor data from one or more hand tracking sensors of the one or more wearable tracking devices; and
obtaining a third portion of the sensor data from one or more wrist tracking sensors of the one or more wearable tracking devices.

12. The system of claim 8, the one or more processors further to:
obtain a stream of image data representing a video depicting a first-person perspective view associated with the robot, the stream of image data generated using one or more image sensors of the robot;
update, based at least on the image data and the one or more control signals, an artificial intelligence (AI) policy associated with the robot; and
train, using the AI policy, one or more second robots.

13. The system of claim 8, the one or more processors further to:
determine, using the sensor data, the one or more first poses associated with the one or more hand complexes of the user, wherein the one or more first poses are indicative of at least one of:
one or more locations associated with one or more joints of the one or more hand complexes in three-dimensional (3D) space,
one or more orientations, in the 3D space, of one or more portions of the one or more hand complexes, or
one or more joint angles associated with the one or more portions of the one or more hand complexes.

14. The system of claim 8, the one or more processors further to:
obtain second sensor data generated using one or more second sensors of one or more spatial computing devices, wherein the second sensor data is indicative of one or more third poses associated with one or more non-manual body parts of the user;
determine, based at least on the second sensor data, one or more second control signals for one or more second motors of the robot; and
send, to the one or more second motors, the one or more second control signals.

15. The system of claim 8, the one or more processors further to:
determine, based at least on the sensor data, one or more joint angles associated with one or more portions of the one or more hand complexes,
wherein the determination of the one or more control signals is further based at least on the one or more joint angles.

16. The system of claim 8, wherein:
the robot is a humanoid robot,
the one or more components are associated with one or more second hand complexes of the humanoid robot that correspond to the one or more hand complexes of the user, and
the one or more motors control movement of the one or more components.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models (MMLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to perform one or more movements of a humanoid robot, wherein an artificial intelligence (AI) of the humanoid robot is trained to perform the one or more movements, at least, by obtaining sensor data from a plurality of sensors of different modalities, the plurality of sensors including at least one or more spatial computing devices for tracking motion of one or more non-manual portions of a user and one or more wearable tracking devices for tracking motion of one or more hand complexes of the user.

19. The one or more processors of claim 18, the processing circuitry further to:
control, based at least on first sensor data obtained using the one or more spatial computing devices, one or more first movements of one or more first components of the humanoid robot that correspond to the one or more non-manual portions of the user; and
control, based at least on second sensor data obtained using the one or more wearable tracking devices, one or more second movements of one or more second components of the humanoid robot that correspond to the one or more hand complexes of the user.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more large language models (LLMs);
a system for performing operations using one or more vision language models (VLMs);
a system for performing operations using one or more multi-modal language models (MMLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
